(19) United States
(12) Patent Application Publication
(10) Pub. No.: US 2004/0226537 A1
(43) Pub. Date: Nov. 18, 2004

(54) Exhaust line of an internal combustion engine having controllable exhaust flaps

(76) Inventors: Wolfgang Held, Monsheim (DE); Thomas Rauner, Blaustein (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/790,245

(22) Filed: Mar. 2, 2004

(30) Foreign Application Priority Data
Mar. 3, 2003 (DE) 103 09 468.7

(51) Int. Cl. F01N 3/00; F02D 1/00

(52) U.S. Cl. 123/324

(57) ABSTRACT

A method of triggering the exhaust flaps in an exhaust system is used whereby a vacuum storage device is connected via a nonreturn valve to an intake system. The vacuum storage device is connected to an exhaust system via a triggerable solenoid valve (13) in parallel with the intake system. The triggerable solenoid valve is triggerable by an engine control unit. The triggering variable is determined in the engine control unit by at least one engine characteristics map, which includes the rotational speed, engine load and engaged gear.

### BACKGROUND OF THE INVENTION

This application claims the priority of German patent application 103 09 468.7, filed Mar. 03 2003, the disclosure of which is expressly incorporated by reference herein.

The present invention relates to an exhaust line of an internal combustion engine of the type disclosed in DE 42 12 215.

In the known configuration, the exhaust line of an internal combustion engine is provided with a startup catalytic converter installed near the engine. A central channel, which is surrounded by a catalytic converter body, is provided in the housing of the startup catalytic converter. This central channel is controllable by an exhaust flap such that the exhaust flows through the body of the catalytic converter when the flap is closed and the exhaust flows through the central channel when the flap is open. Such an arrangement is frequently used to bring the catalytic converter to the operating temperature as rapidly as possible.

### SUMMARY OF THE INVENTION

With the triggering of the exhaust flap in accordance with the present invention, a double-pass exhaust system with one preliminary catalytic converter and one main catalytic converter is provided. The preliminary catalytic converters here again sits directly behind the bends in an area near the engine, and the main catalytic converter is integrated into the end muffler. With today's vehicles, because of the high demands, often there is only a minimum amount of space for integrating the exhaust system. Therefore with modern exhaust systems, which should meet all the statutory noise limits at a minimum exhaust pressure and a high engine load despite their low muffler volume, the muffler is configured as a flap end muffler.

According to the features of the method of the present invention, these exhaust flaps are to be triggered as a function of a stored engine characteristics map stored. A wide variety of parameters, such as the gas pedal gradient, the engine temperature, the lambda values, etc. may be included in the engine characteristics map, but in particular the vehicle speed, the engine rpm, the gear engaged and the engine load are essential parameters that are included in triggering the exhaust flaps.

Definite improvements in the performance requirements in low gears can be achieved through the triggering of the exhaust flaps as a function of the engine characteristics map according to the present invention.

Another advantage is that separate engine characteristics maps can be stored, providing the driver with either a very sporty performance of the vehicle, for example, or a more comfort-emphasized driving sound when driving in city traffic and thus providing a quiet driving performance. This yields a definite increase in comfort for the driver of the vehicle.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic diagram showing the basic configuration of a flap exhaust system, and

FIG. 2 is a flow diagram showing the individual method steps for implementing the method of the present invention.

### DETAILED DESCRIPTION OF THE DRAWINGS

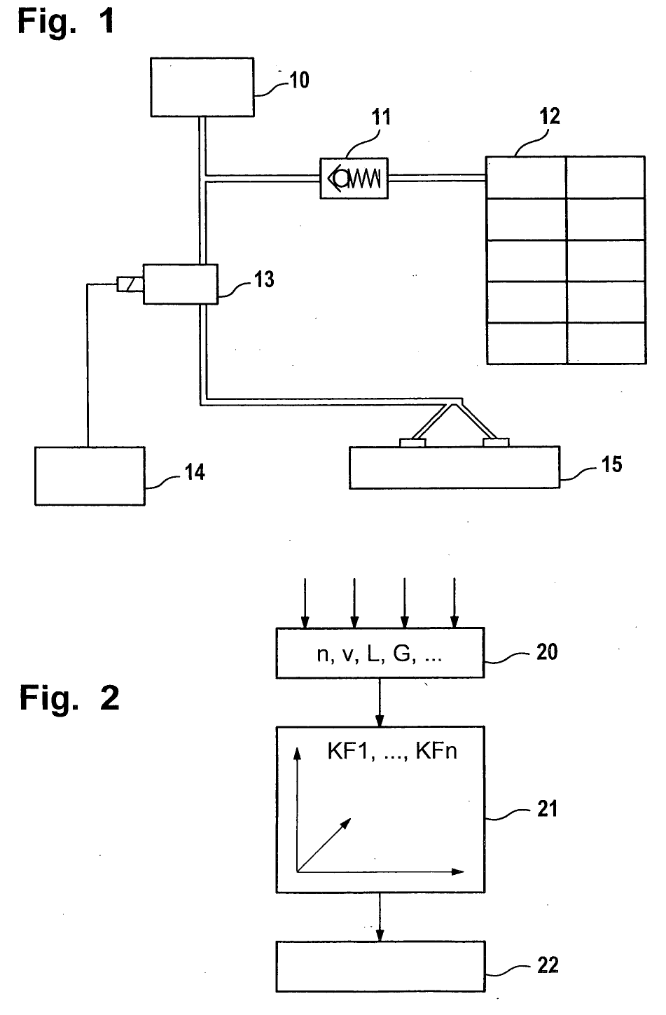

FIG. 1 shows the basic configuration of a flap exhaust system, including a vacuum storage device 10 connected to an intake system 12 by a nonreturn valve 11. In parallel with this the vacuum storage device 10 is connected to a solenoid valve 13 which is triggered by the engine control unit 14 and whose output is sent to the exhaust system 15. The functioning of such an exhaust system with triggerable exhaust flaps is essentially known and therefore need not be explained in detail.

FIG. 2 shows the essential steps for implementing the inventive method. In a first working step 20, the various input variables for determining the triggering process of the exhaust flaps are determined. These input variables include for example the rotational speed n, the vehicle speed v, the load L, the engaged gear G and other contemplated variables, such as the temperature and the driver's intent. In a following working step 21, the control variables are determined with the help of at least one stored engine characteristics map for the exhaust flaps on the basis of the input variables thus determined. It is also contemplated here that different engine characteristics maps can be accessed, all such maps being stored in the engine control unit 14. Possible engine characteristics maps for triggering the exhaust flaps are indicated clearly in working step 21 as the engine characteristics map KF1 through engine characteristics map KFn. As soon as the shifting conditions for the exhaust flaps have been met in working step 21, the output of a signal to the solenoid valve 13 takes place in working step 22. This releases the passage from the vacuum storage device to the vacuum dashpot of the exhaust flaps. Because the vacuum storage device of the exhaust system is connected directly to the intake system via a nonreturn valve 11, a vacuum is built up in the intake system and the vacuum storage device is acted upon when the combustion engine is running and the throttle valve is closed. The vacuum storage device used is not absolutely necessary for the triggering. The exhaust flaps may also be operated directly by electric actuators. Triggering of the actuators may also be accomplished by the engine control unit.

With the triggering of the exhaust flaps according to the present invention, whereby not only the speed of the vehicle but also the overall requirements of the engine and the exhaust system are taken into account, to various problems can now be solved in a controlled manner. Thus, for example, interfering gas exchange noises such as droning or drumming which occur at certain rotational speeds and engine loads can be reduced or completely eliminated by a controlled triggering of the exhaust flaps. At the same time, an extremely sporty sound can be stored in the engine characteristics map in the control unit and thus give the driver a feeling of extreme agility.

In addition, racing operation can be recognized in vehicles which are allowed as street-legal vehicles and are also designed for racing operation. This is accomplished by recognizing the required engine power and/or torque. In this manner, engine characteristics maps for the exhaust flaps that are based on optimum power and torque can be selected.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed:

1. Method of triggering exhaust flaps in a vehicle exhaust system comprising triggering the triggerable solenoid valve by an engine control unit to open or close the exhaust flaps as a function of at least one stored engine characteristics map which includes the rotational speed, engine load and the gear engaged.

2. Method as claimed in claim 1, further comprising storing a plurality of engine characteristic maps in the engine control unit.

3. Method as claimed in claim 2, further comprising selecting the appropriate engine characteristic map based on preselectable criteria.

4. Method as claimed in claim 3, further comprising switching between street vehicle operation and racecar operation.

5. Exhaust system, comprising triggerable exhaust flaps, a vacuum storage device operatively connected via a nonreturn valve to an intake system and to an exhaust system via a triggerable solenoid valve in parallel therewith, and a plurality of engine characteristics maps stored in an engine control unit for triggering the triggerable solenoid valve to open and close the exhaust flaps as a function of at least one stored engine characteristics map which includes the rotational speed, engine load and the engaged gear.

6. Exhaust system as claimed in claim 5, wherein an appropriate one of the engine characteristics maps is selected in the control unit from the stored engine characteristics maps depending on a preselectable requirement.

7. Exhaust system as claimed in claim 6, wherein the selected appropriate engine characteristics map is configured to provide a switch between operation of the vehicle as a street vehicle and as a racecar.
